(19) United States
(12) Patent Application Publication
(10) Pub. No.: US 2026/0069063 A1
(43) Pub. Date: Mar. 12, 2026

(54) CLAMPING DISH ASSEMBLY

(71) Applicant: J&G Smart Solutions, LLC, Cleveland, OH (US)

(72) Inventor: Jennifer Harmon, Cleveland, OH (US)

(73) Assignee: J&G Smart Solutions, LLC, Cleveland, OH (US)

(21) Appl. No.: 19/322,806

(22) Filed: Sep. 9, 2025

Related U.S. Application Data
(60) Provisional application No. 63/692,465, filed on Sep. 9, 2024.

(51) Int. Cl. A47G 19/10; F16M 13/02

(52) U.S. Cl. CPC A47G 19/10; F16M 13/02

(57) ABSTRACT

A dish assembly is provided for removably securing to a support structure. A clamp includes a support-surface-engaging portion defining a circular indent with wall protrusions and a brace assembly that, when actuated, urges the support-surface-engaging portion against the support surface. A cooperating dish has a bottom circular locking portion with channels having axial entries and circumferential segments. Pressing the dish into the indent causes the protrusions to enter the axial entries; subsequent rotation causes the protrusions to follow the circumferential segments to lock the dish. A bias element within the indent urges the dish away from the support surface to resist reverse rotation. The brace assembly may include a lateral member, a screw-driven pivot pin, and a movable brace with a contact structure such as a pivoting pressure plate or a curved portion for engaging a bar. Release requires depressing the dish and counter-rotating.

### TECHNICAL FIELD

The present disclosure relates generally to food dishes and more particularly to a dish assembly for removably securing to a support structure.

### BACKGROUND

Caregivers frequently employ suction-base bowls, adhesive mats, or weighted dishes to reduce spills. These approaches can lose holding force on textured, porous, or contaminated surfaces. Suction bases can be peeled at an edge. Adhesives can leave residue or require replacement. Large mats can occupy usable surface area and may not fit small trays.

Edge-gripping devices exist but can require a narrow thickness range or rigid overhang to function. Some devices can mar the support structure or are cumbersome to attach. Quick attachment and removal by an adult is desirable, while resisting removal attempts by a child.

Another challenge is the connection between the dish and the clamp. Friction fits, magnets, or simple snaps can release under torsional or prying loads. A positive, releasable lock is desirable. A release motion that is intuitive for an adult yet resists casual rotation or lifting by a child is also desirable.

### SUMMARY

Accordingly, there remains a need for a compact clamping system that secures to varied support structures and for a cooperating dish interface that provides a positive, releasable lock with a child-resistant release action.

The present disclosure provides a dish assembly for removably securing a dish to a support surface using a clamp including a circular indent for releasably locking in the bowl and having a bias element urging the dish away from the support surface to resist reverse rotation.

While a number of features are described herein with respect to embodiments of the invention; features described with respect to a given embodiment also may be employed in connection with other embodiments. The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention in which similar reference numerals are used to indicate the same or similar parts in the various views.

FIG. 1 is a perspective view of an embodiment of a clamp including a brace assembly having a curved portion for engaging a bar.

FIG. 2 is a perspective view of an embodiment of a clamp including a brace assembly having a pressure plate.

FIG. 3 is a perspective view of an embodiment of a dish assembly including the clamp of FIG. 2.

FIG. 4 is an exploded view of an embodiment of a dish assembly including the clamp of FIG. 1.

FIG. 5 is an exploded view of the dish assembly of FIG. 3.

FIG. 6 is a perspective view of an actuator of the clamp of FIGS. 1 and 2.

FIG. 7 is a front view of the actuator of FIG. 6.

FIG. 8 is a back view of the actuator of FIG. 6.

FIG. 9 is a right side view of the actuator of FIG. 6.

FIG. 10 is a left side view of the actuator of FIG. 6.

FIG. 11 is a top view of the actuator of FIG. 6.

FIG. 12 is a bottom view of the actuator of FIG. 6.

FIG. 13 is a perspective view of a support-surface-engaging portion of the clamp of FIGS. 1 and 2.

FIG. 14 is a front view of the actuator of FIG. 13.

FIG. 15 is a back view of the actuator of FIG. 13.

FIG. 16 is a right side view of the actuator of FIG. 13.

FIG. 17 is a left side view of the actuator of FIG. 13.

FIG. 18 is a top view of the actuator of FIG. 13.

FIG. 19 is a bottom view of the actuator of FIG. 13.

FIG. 20 is a top perspective view of a dish of the dish assembly of FIGS. 4 and 5.

FIG. 21 is a bottom perspective view of the dish of FIG. 20.

FIG. 22 is a front view of the dish of FIG. 20.

FIG. 23 is a back view of the dish of FIG. 20.

FIG. 24 is a right side view of the dish of FIG. 20.

FIG. 25 is a left side view of the dish of FIG. 20.

FIG. 26 is a top view of the dish of FIG. 20.

FIG. 27 is a bottom view of the dish of FIG. 20.

FIG. 28 is a perspective view of the curved portion of the dish assembly of FIG. 4.

FIG. 29 is a front view of the dish of FIG. 28.

FIG. 30 is a back view of the dish of FIG. 28.

FIG. 31 is a right side view of the dish of FIG. 28.

FIG. 32 is a left side view of the dish of FIG. 28.

FIG. 33 is a top view of the dish of FIG. 28.

FIG. 34 is a bottom view of the dish of FIG. 28.

FIG. 35 is a perspective view of the pressure plate of the dish assembly of FIG. 5.

FIG. 36 is a front view of the pressure plate of FIG. 35.

FIG. 37 is a back view of the pressure plate of FIG. 35.

FIG. 38 is a right side view of the pressure plate of FIG. 35.

FIG. 39 is a left side view of the pressure plate of FIG. 35.

FIG. 40 is a top view of the pressure plate of FIG. 35.

FIG. 41 is a bottom view of the pressure plate of FIG. 35.

FIG. 42 is a perspective view of a pivot pin of the brace assembly of FIGS. 4 and 5.

FIG. 43 is a front view of the pivot pin of FIG. 42.

FIG. 44 is a back view of the pivot pin of FIG. 42.

FIG. 45 is a right side view of the pivot pin of FIG. 42.

FIG. 46 is a left side view of the pivot pin of FIG. 42.

FIG. 47 is a top view of the pivot pin of FIG. 42.

FIG. 48 is a bottom view of the pivot pin of FIG. 42.

FIG. 49 is a right side view of the dish assembly of FIG. 3 with the pressure plate located in a raised position.

FIG. 50 is a right side view of the dish assembly of FIG. 49 with the pressure plate located in a lowered position.

FIG. 51 is a right side view of the dish assembly of FIG. 49 with the pressure plate in the raised position and secured to a support structure.

The present invention is described below in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

### DETAILED DESCRIPTION

The present disclosure provides a dish assembly configured for removable attachment to a support structure. The assembly includes a dish having a bottom circular locking portion with channels having axial entries and circumferential segments, and a cooperating clamp including a support-surface-engaging portion that overlies the support surface and defines a circular indent sized to receive the locking portion of the bowl. Protrusions along a wall of the indent are configured to enter the axial entries when the dish is pressed into the indent and to engage the circumferential segments upon relative rotation to releasably lock the dish to the clamp. A bias element within the indent urges the dish away from the support surface when seated to resist reverse rotation from a locked position. A brace assembly mechanically coupled to the support-surface-engaging portion is actuable to engage an edge of the support structure and urge the support-surface-engaging portion against the support surface to secure the clamp.

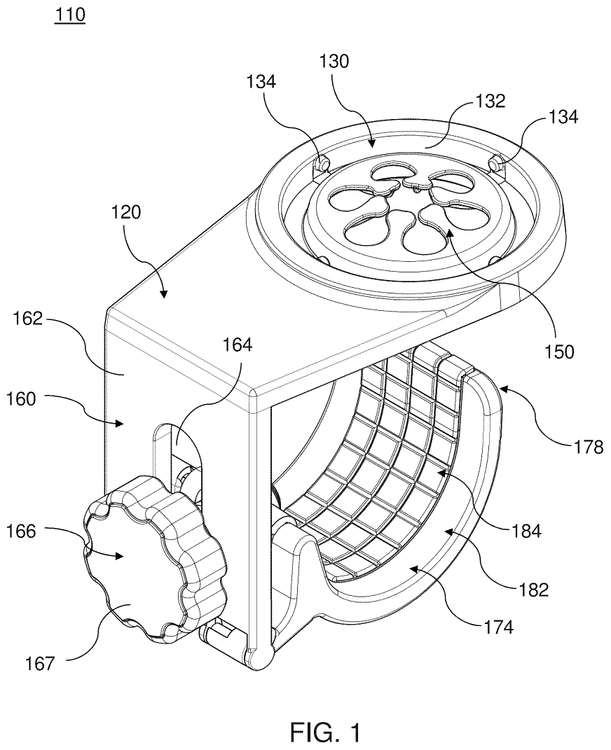

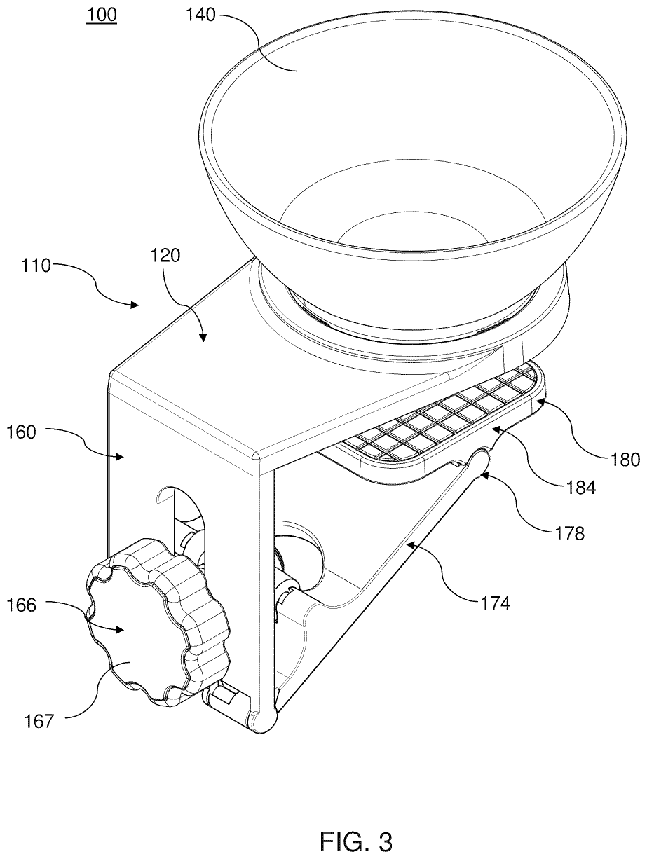

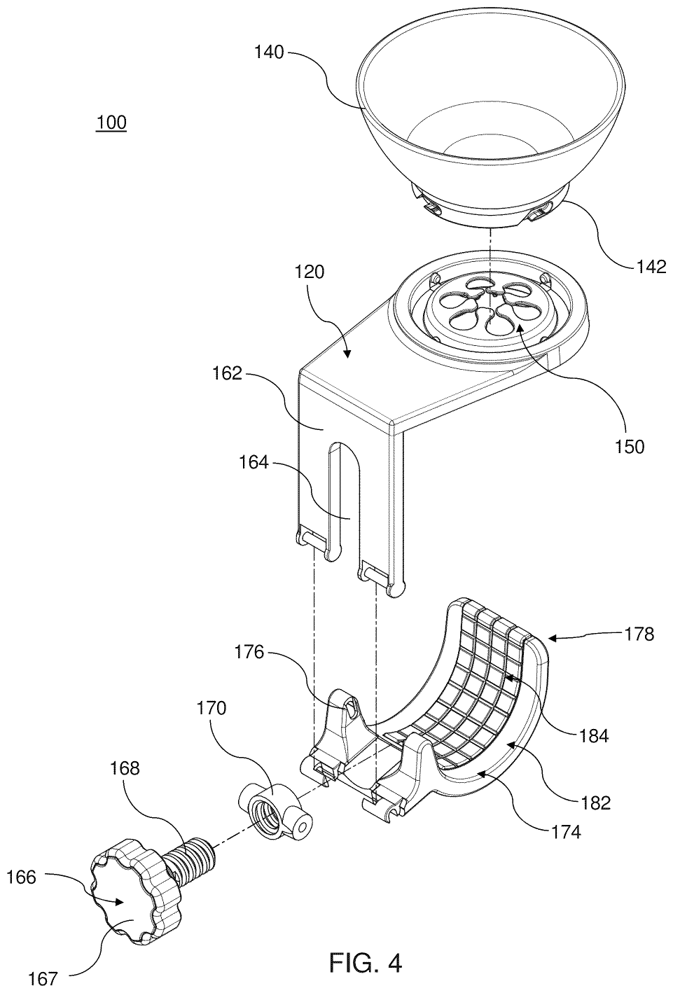

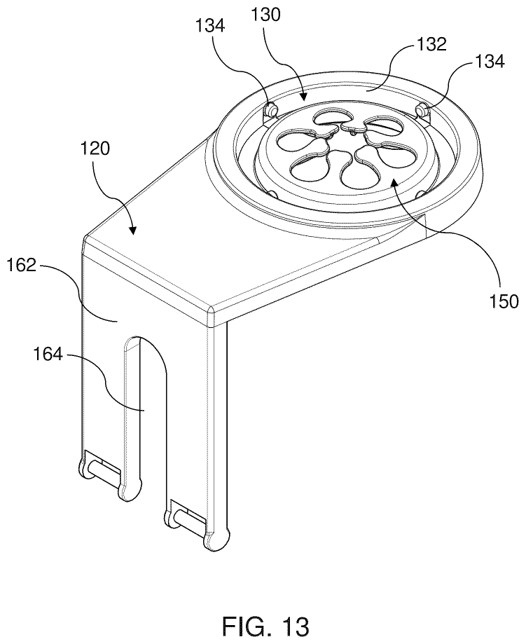

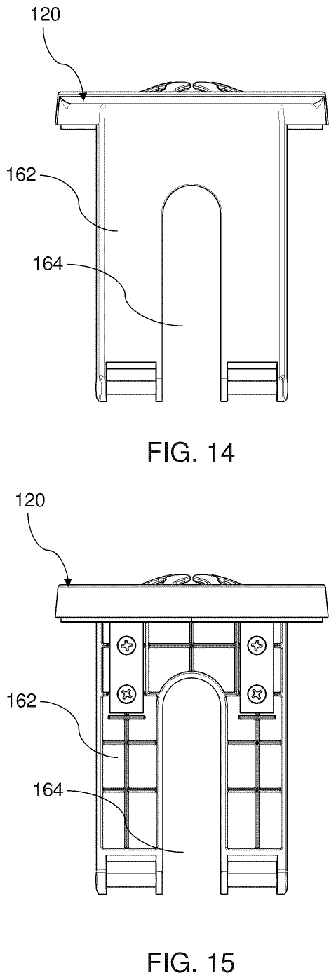

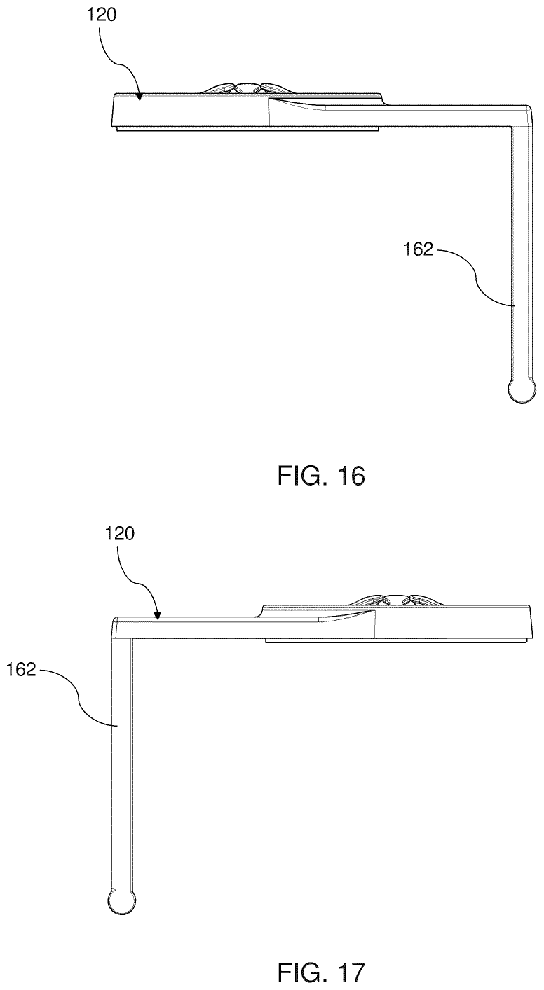

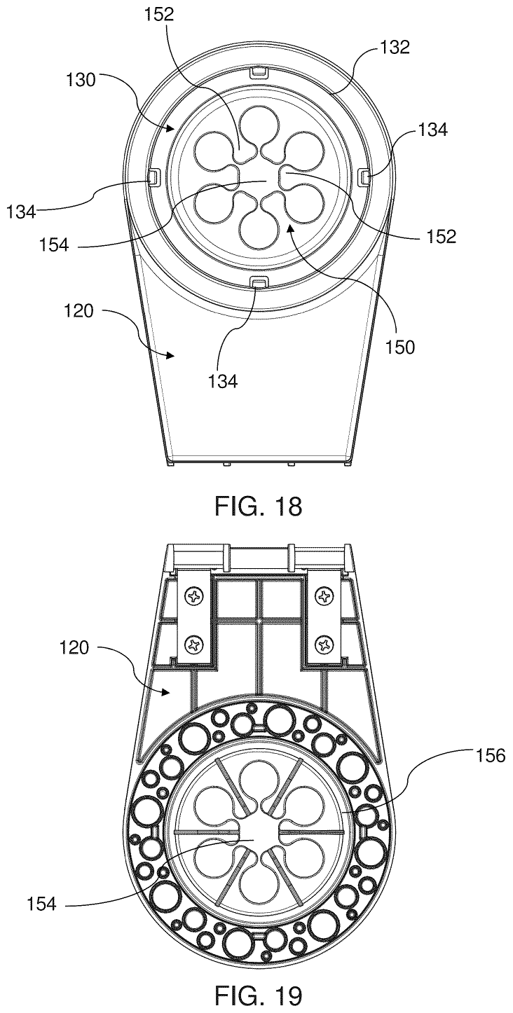

Turning to FIGS. 1-5, a dish assembly 100 is shown for removably securing a dish to a support structure 190. The assembly 100 includes a dish 140 and a clamp 110. The dish has a bottom circular locking portion 142 that defines a plurality of channels 144. Each channel 144 includes an axial entry 146 and a circumferential segment 148. With exemplary reference to FIGS. 13-19, the clamp 110 includes a support-surface-engaging portion 120 configured to overlie a support surface 191 of the support structure 190 and defining a circular indent 130 sized to receive the circular locking portion 142. A wall 132 of the indent 130 carries a plurality of protrusions 134 positioned to enter the axial entries 146 of the dish when the dish 140 is pressed into the indent 130. The protrusions 134 are also positioned to follow the circumferential segments 148 upon relative rotation to releasably lock the dish 140 to the clamp 110.

The clamp 110 also includes a bias element 150 located within the indent 130. The bias element 150 urges the dish 140 away from the support surface 191 when the circular locking portion 142 is received in the indent 130 to resist reverse rotation from a locked position. For example, the circumferential segments 148 may include a downward portion (i.e., located axially towards a bottom of the circular locking portion) referred to as locking channels 151 that the protrusions 134 are urged into by the bias element 150 when urging the dish 140 away from the support surface 191. As is described in further detail below, to unlock the dish 140, a user may be required to apply a downward force (i.e., towards the support surface 191) on the dish 140 while rotating the dish 140 in an unlocking direction (i.e., opposite the locking direction).

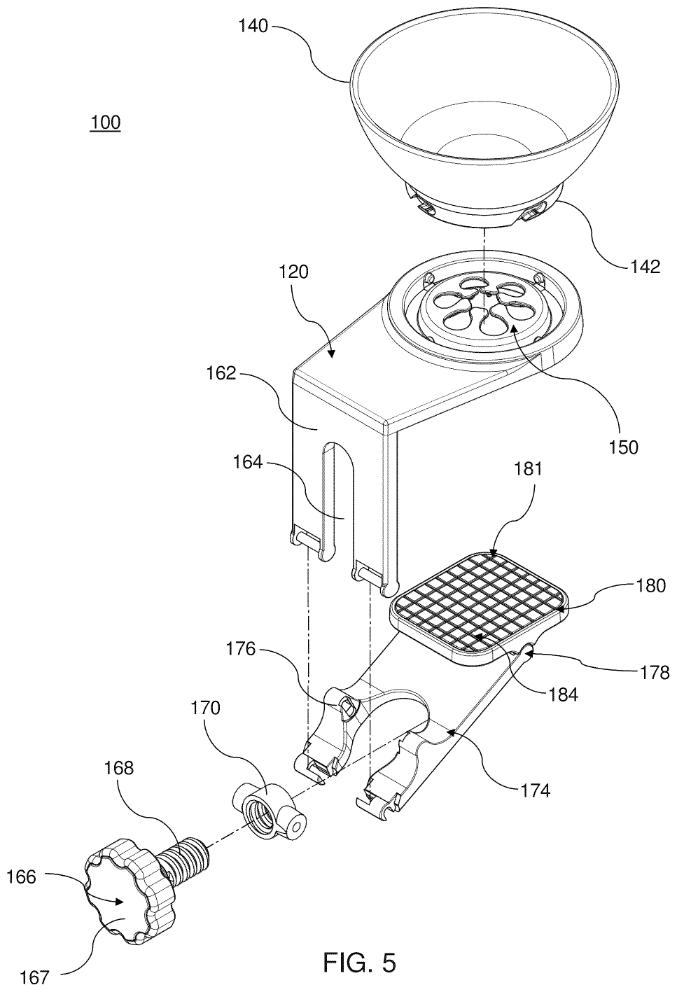

With exemplary reference to FIG. 5, during attachment the user aligns the circular locking portion 142 with the indent 130. The user presses the dish 140 downward so that the protrusions 134 enter the axial entries 146 and then rotates the dish 140 relative to the clamp 110 so that the protrusions 134 travel along the circumferential segments 148. The bias element 150 urges the circular locking portion 142 away from the support surface 191 to maintain engagement and to resist unintended reverse rotation. In some embodiments release is performed by depressing the dish 140 against the bias element 150 to realign the protrusions 134 with the axial entries 146 and counter-rotating to permit withdrawal of the circular locking portion 142 from the indent 130 (e.g., as described in dependent claims).

In some embodiments the indent 130 includes a central opening 154 and an interior annular ring 156 that supports a plurality of resilient biasing members 152 extending into the central opening 154 at an upward inclination. The biasing members 152 contact a bottom surface 143 of the circular locking portion 142 when the dish 140 is seated in the indent 130.

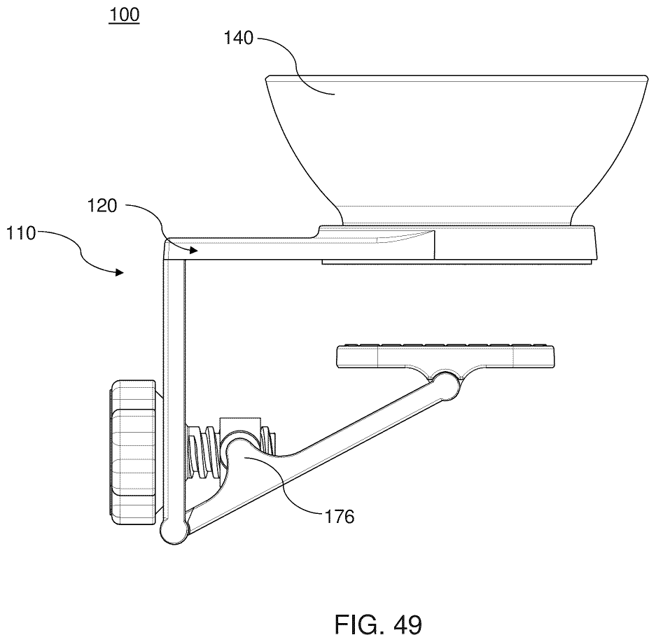

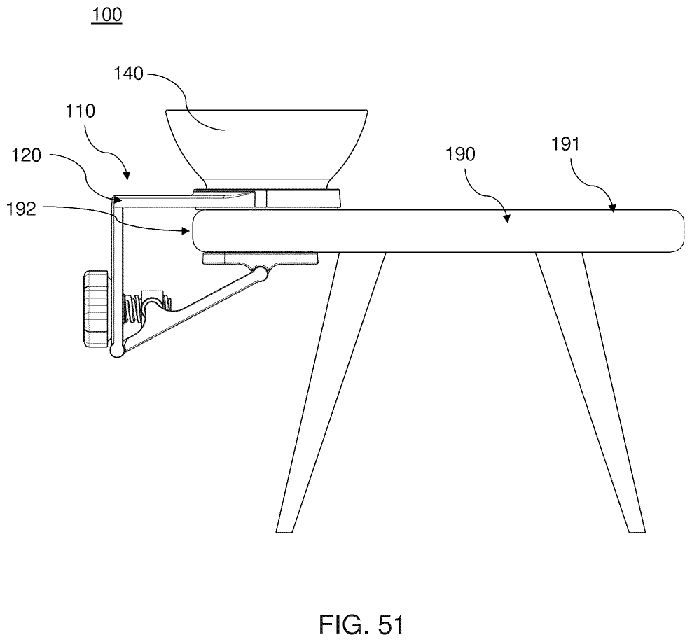

Turning to FIGS. 49-51, the clamp 110 further includes a brace assembly 160 configured to secure the support-surface-engaging portion 120 against the support surface 191. The brace assembly 160 is mechanically coupled to the support-surface-engaging portion 120 and actuable to engage an edge 192 of the support structure 190 to urge the support-surface-engaging portion 120 against the support surface 191.

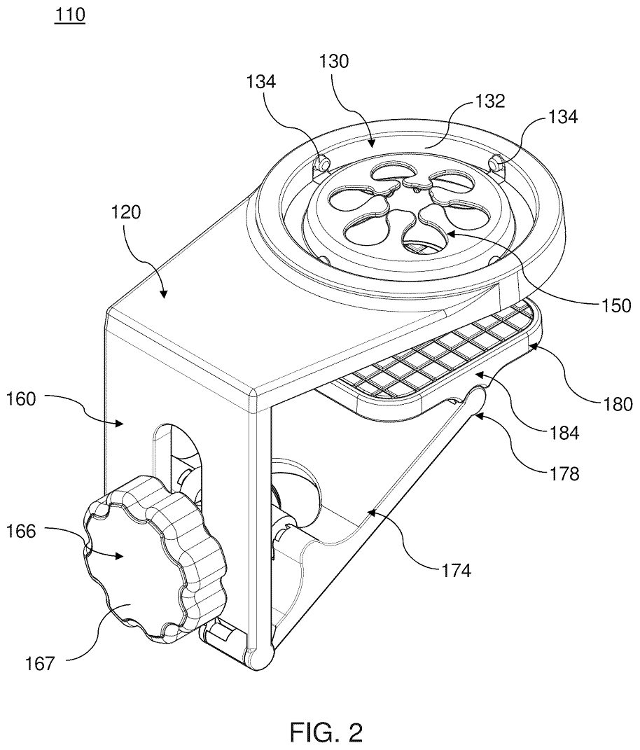

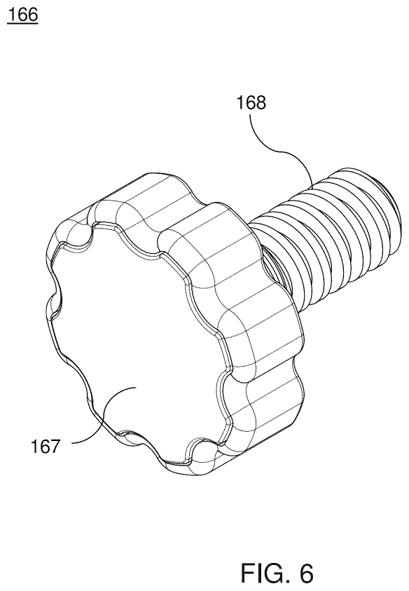

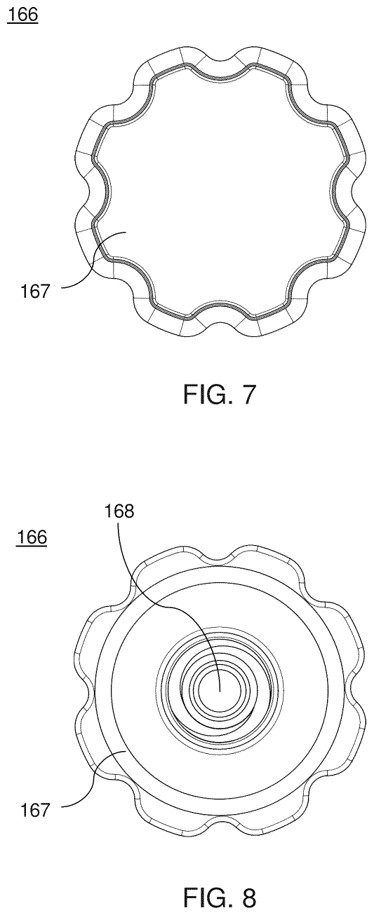

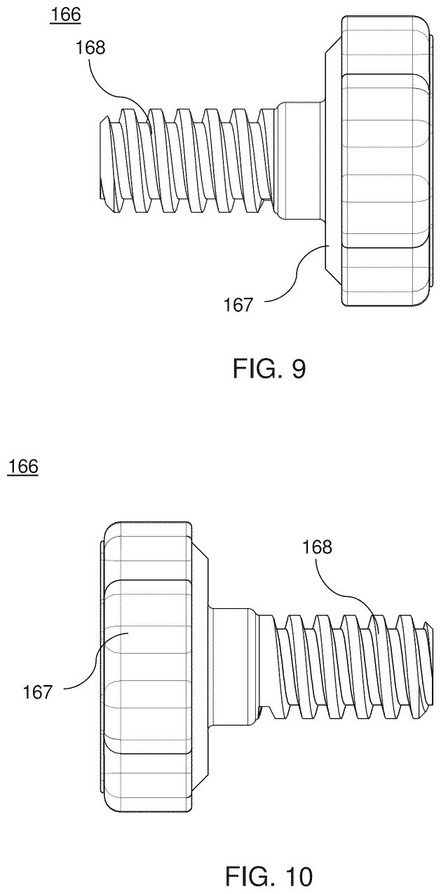

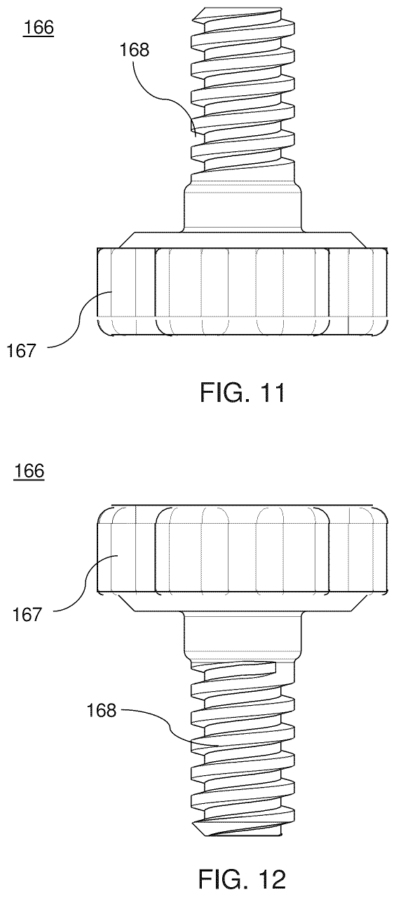

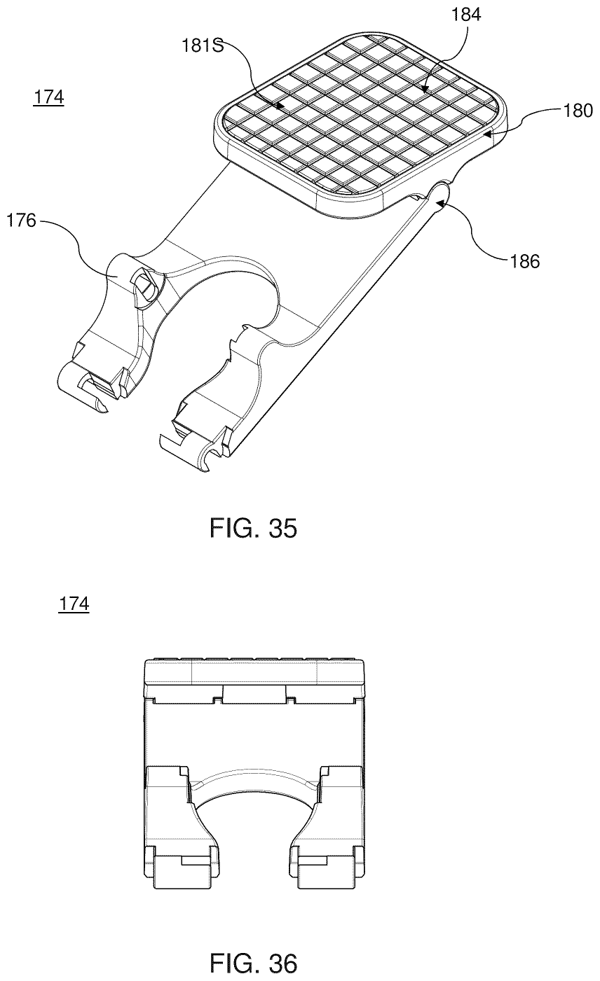

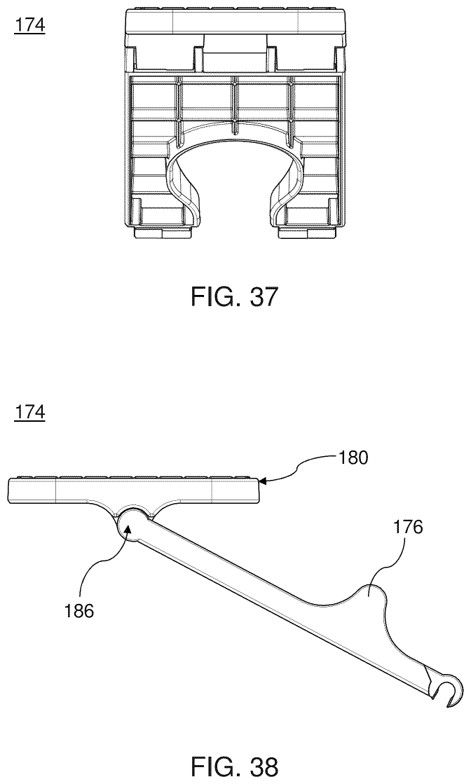

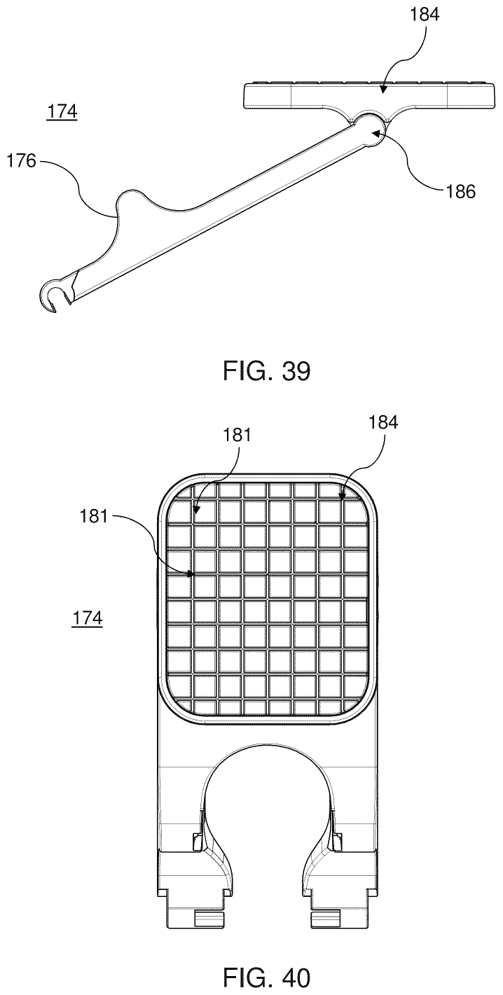

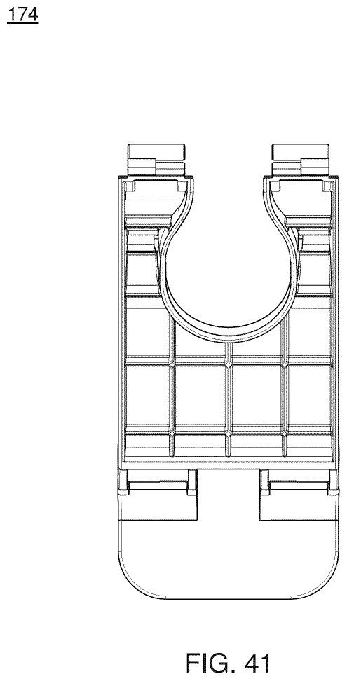

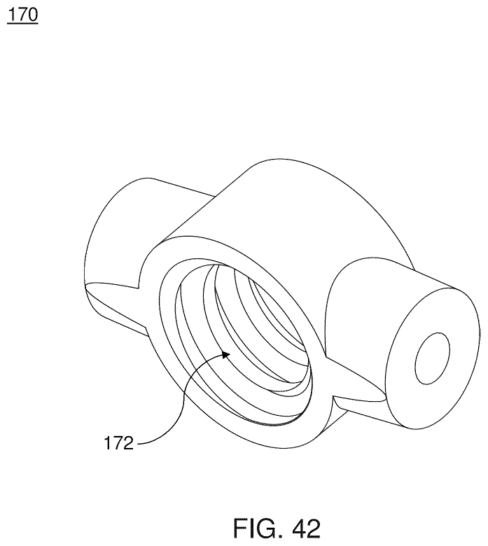

In the embodiment illustrated in FIGS. 2, 3, 5, and 35-41, the brace assembly 160 includes a lateral member 162, an actuator 166, a pivot pin 170, and a movable brace 174. The lateral member 162 is positioned to engage an edge 192 of the support structure 190 and defines an elongate slot 164 that extends through a thickness of the lateral member 162 from an interior side adjacent the support-surface-engaging portion 120 to an exterior side. Turning to FIGS. 6-12, the actuator 166 includes a grip 167 coupled to a screw 168, with the screw 168 extending through the slot 164 from the exterior side to the interior side.

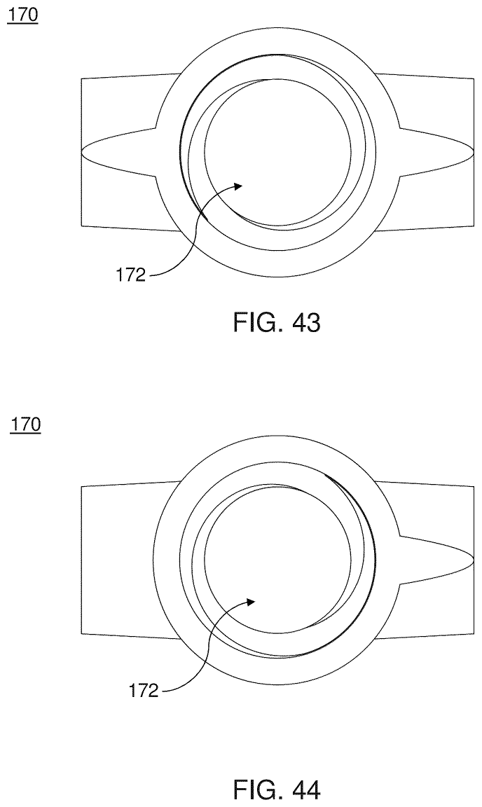

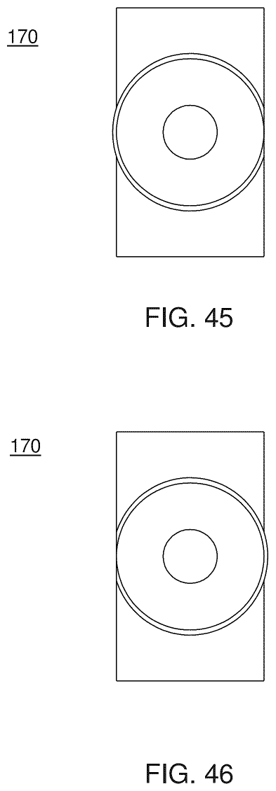

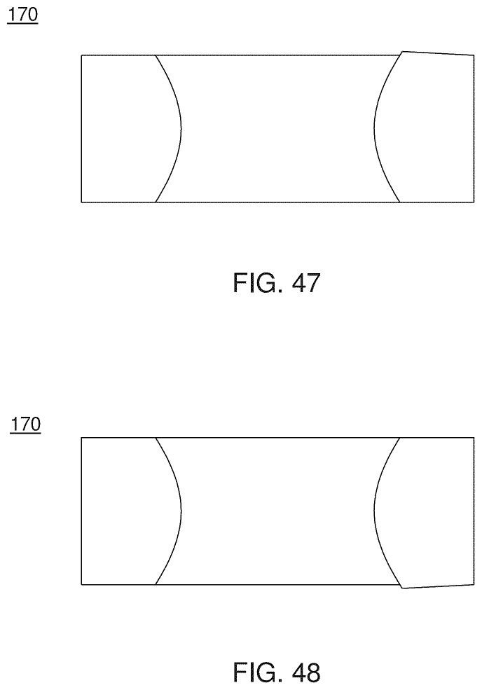

With exemplary reference to FIGS. 42-48, the pivot pin 170 has a threaded bore 172 for receiving the screw 168. The movable brace 174 includes a proximal end, a distal end 178, a pivot connector 176, and a contact structure 184. The movable brace 174 is pivotably coupled to the lateral member 162 at the proximal end. The pivot connector 176 is located between the proximal end and a distal end 178 and is pivotably coupled to the pivot pin 170. The contact structure 184 engages the support structure 190.

The pivoting connections within the brace assembly 160 may be implemented using a variety of engagement methods. For example, the connection between the pivot pin 170 and the movable brace 174, as well as the pivot connector 176, may be secured by snap-fit joints, inserted pins, rivets, or other suitable mechanical fasteners. In other embodiments threaded fasteners, bushings, or integral hinges may be employed. The choice of connection type may depend on desired strength, ease of assembly, or ability to disassemble for cleaning or replacement.

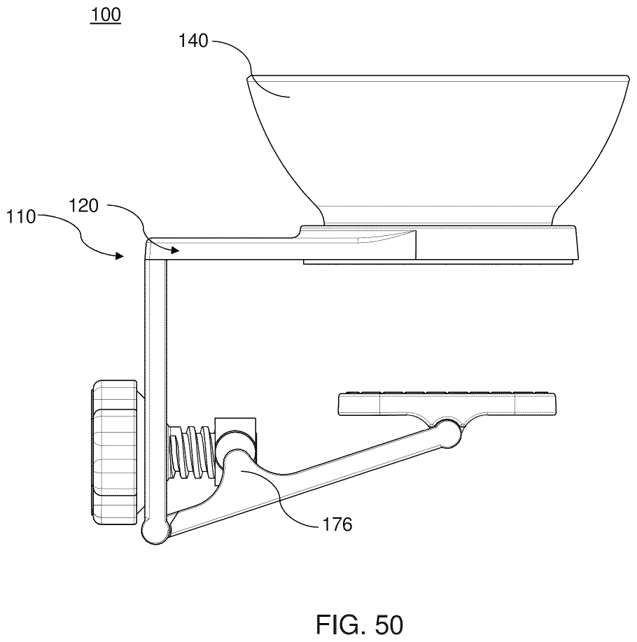

Turning to FIGS. 49 and 50, during tightening, rotation of the grip 167 in a tightening direction advances the screw 168 in the threaded bore 172 and draws the pivot pin 170 toward the grip 167. This motion decreases an angle between the lateral member 162 and the movable brace 174 and translates the movable brace 174 (guided by the slot 164) to urge the support-surface-engaging portion 120 against the support surface 191. Conversely, during loosening, rotation of the grip 167 in the opposite direction retracts the screw 168 relative to the threaded bore 172 to drive the pivot pin 170 away from the grip 167. This motion increases the angle between the lateral member 162 and the movable brace 174 and moves the movable brace 174 to reduce the urging of the support-surface-engaging portion 120 against the support surface 191.

The contact structure 184 may include a pressure plate 180 pivotably coupled adjacent the distal end 178 of the movable brace 174. In this embodiment, the pressure plate 180 presents a contact face configured to bear against an underside of the support structure 190 when the actuator 166 is tightened to urge the support-surface-engaging portion 120 against the support surface 191. A joint 186 couples the pressure plate 180 to the movable brace 174 near the distal end 178 and permits angular self-alignment of the pressure plate 180 to the local underside surface (e.g., to accommodate non-parallel or contoured undersides). In some implementations the pressure plate 180 carries a compliant friction pad 181 on the contact face (e.g., an elastomeric layer) to increase friction and distribute load.

The joint 186 may provide rotation of the pressure plate 180 relative to the movable brace 174. In one example the joint 186 is a pin joint with a hinge axis oriented generally transverse to the slot 164 to allow the pressure plate 180 to pitch as it seats against the underside of the support structure 190. In another example the joint 186 is a ball-and-socket coupling or a clevis with a low-friction bushing to provide additional degrees of freedom (e.g., pitch and roll) for improved seating. In each case the pressure plate 180 remains rotatable relative to the movable brace 174 so that tightening maintains distributed contact while reducing point loading.

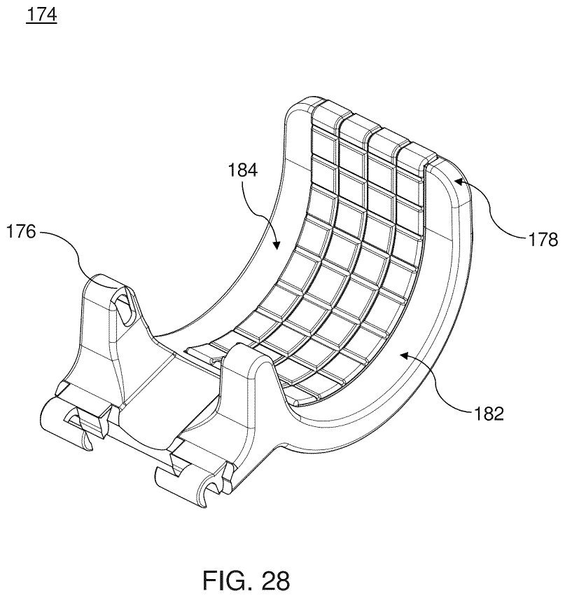

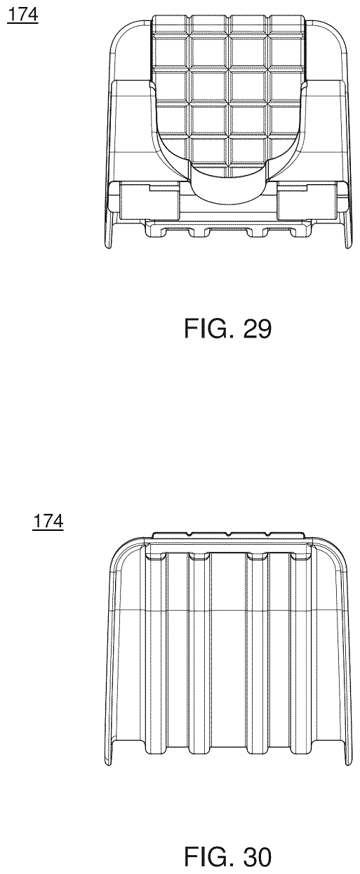

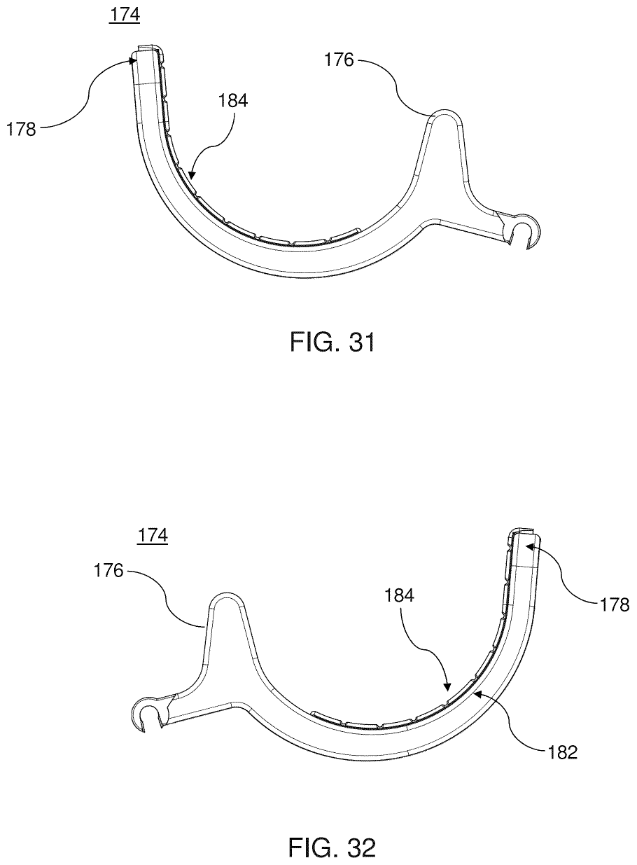

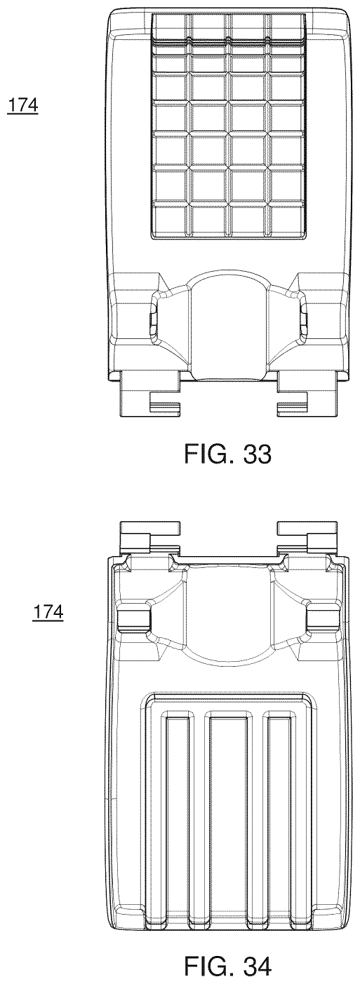

Turning to FIGS. 28-34, in an alternative configuration, the contact structure 184 may include a curved portion 182 formed on the movable brace 174 between the pivot connector 176 and the distal end 178 and configured to engage, e.g., a bar of the support structure 190. The curved portion 182 defines an inner contact region sized to nest against a cylindrical or rounded bar (e.g., highchair tray rail) so that tightening draws the curved portion 182 around the bar while the distal end 178 may remain spaced from the bar. The curved portion 182 may include a protective sleeve (e.g., polymer overmold or removable boot) to increase friction and reduce marring. This configuration allows the movable brace 174 to act as a hook around the bar while the lateral member 162 reacts the clamping load to secure the support-surface-engaging portion 120 against the support surface 191.

The dish assembly 100 may be used with a variety of support structures. Examples include table tops, highchair trays, benches, countertops, picnic tables, and similar structures presenting a support surface 191 and edge 192. The brace assembly 160 and support-surface-engaging portion 120 may be dimensioned to accommodate different thicknesses and geometries of support structures. This versatility allows the dish assembly 100 to be employed in a wide range of household, restaurant, or portable feeding environments.

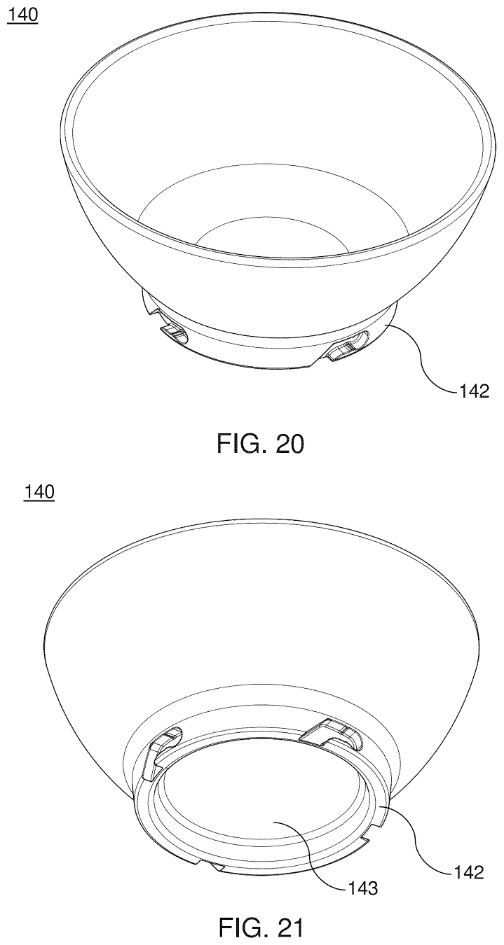

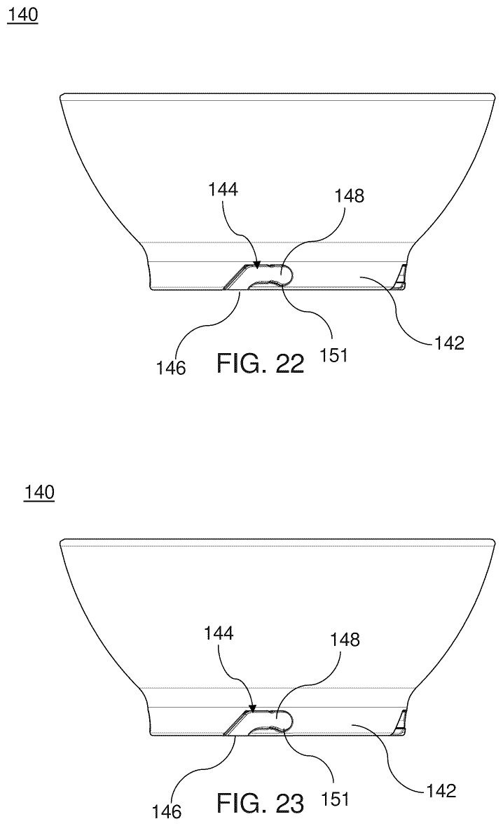

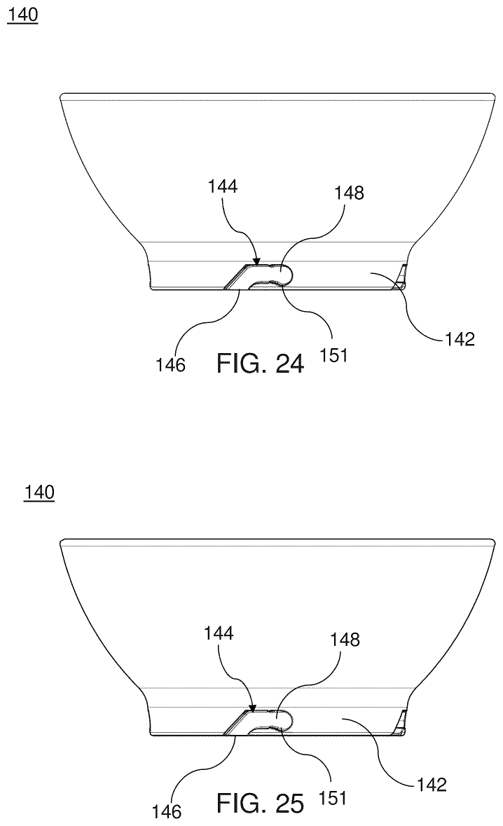

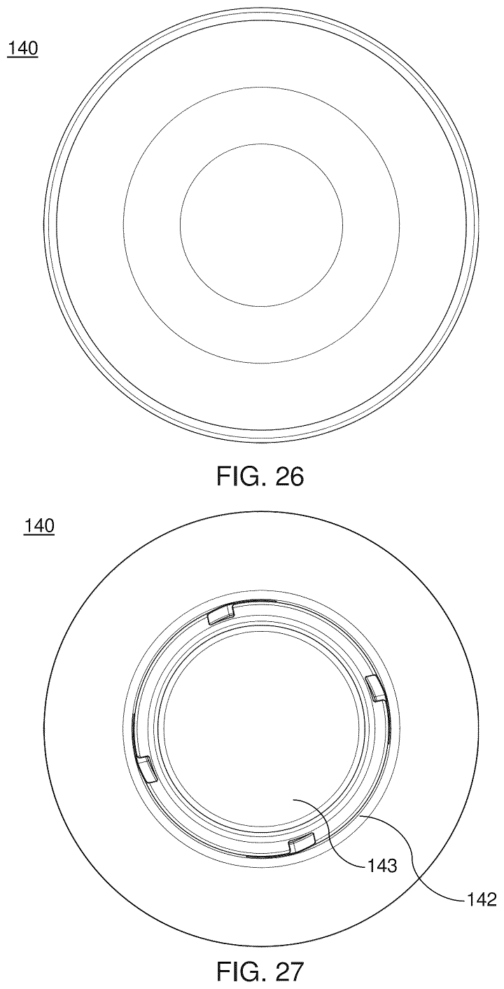

With exemplary reference to FIGS. 20-27, the dish 140 may be any suitable food receptacle, including a bowl, plate, or tray. In bowl embodiments, a continuous sidewall extends upward from a base to define a volume; in plate embodiments, a shallow recess or substantially planar surface with a peripheral rim is provided; in tray embodiments, a raised rim and optional partitions may be provided. In each case, the bottom circular locking portion 142 is integrated with or affixed to an underside of the dish 140 and is dimensioned to cooperate with the indent 130 as described. The dish 140 may be formed from polymer, metal, glass, or composite materials (e.g., polypropylene, stainless steel, silicone), and may be food-contact compliant, dishwasher-safe, and microwave-compatible as desired. Optional features may include a lid, handles or grasp regions, pour spouts, measurement markings, non-stick or textured interiors, or removable inserts, while the geometry, wall thickness, and mass of the dish 140 may vary without affecting operation of the locking interface.

The components of the clamp 110, including the support-surface-engaging portion 120, indent 130, protrusions 134, lateral member 162, movable brace 174, actuator 166, pivot pin 170, and pressure plate 180, may be manufactured from any suitable material (such as metal, polymer, composite, or combinations thereof depending on desired strength, weight, and cost). Suitable polymers include polypropylene, polyethylene, nylon, or reinforced engineering plastics. Suitable metals include stainless steel, aluminum, or coated steel. Elastomeric or silicone materials may be used for friction pads 181, protective sleeves 187, or biasing members 152 to increase grip, flexibility, or resilience. In some embodiments the clamp 110 is formed primarily of injection-molded plastic with embedded or attached metal fasteners for durability, while in other embodiments the clamp 110 may be machined, cast, or stamped metal with polymeric inserts. The choice of materials may be selected to provide food-safe contact surfaces, corrosion resistance, dishwasher compatibility, and long-term durability under repeated clamping and release cycles.

In some embodiments the dish 140 includes a rigid bottom portion in the region of the circular locking portion 142 to provide reliable engagement with the clamp 110. The rigid bottom may be formed of a durable polymer, metal, or composite material that maintains dimensional accuracy for repeated locking and unlocking. The interior food-contact regions of the dish 140 may be formed of, or coated with, food-safe materials such as stainless steel, glass, polypropylene, or silicone to ensure safety, ease of cleaning, and resistance to staining or odor retention. In certain constructions, a dual-material approach may be used in which the circular locking portion 142 is integrally molded from a rigid plastic while an upper bowl portion is formed of a softer or elastomeric material for improved handling and user comfort.

In some embodiments the protrusions 134 are evenly spaced circumferentially around the wall 132 of the indent 130 (e.g., three protrusions at approximately 120° spacing; four protrusions at approximately 90° spacing; six protrusions at approximately 60° spacing). Even spacing may promote balanced load distribution on the circular locking portion 142 during rotation, reducing wobble under lateral loads, and providing uniform engagement with the circumferential segments 148 (including any locking channels 151). Each protrusion 134 may include a chamfered or radiused lead-in to facilitate entry into the axial entries 146 when the dish 140 is pressed into the indent 130, and a crest or shoulder sized to seat against the circumferential segments 148 to provide repeatable tactile feedback at lock. In other embodiments the protrusions 134 can be asymmetric in size or spacing to provide a keyed interface; however, evenly spaced protrusions as shown offer a compact and predictable rotation profile.

To release the dish 140 from the clamp 110, the user may depress the dish 140 toward the support surface 191 to compress the bias element 150 (e.g., biasing members 152), thereby axially displacing the circular locking portion 142 so that the protrusions 134 are disengaged from the locking channels 151 and can traverse the circumferential segments 148 in an unlocking direction. While maintaining the depression, the user rotates the dish 140 relative to the clamp 110 in a direction opposite the locking direction until the protrusions 134 are angularly aligned with the axial entries 146. The user then lifts the dish 140 to withdraw the circular locking portion 142 from the indent 130. In some implementations audible or tactile cues (e.g., detents or ramps) indicate the locked and unlocked positions, and the bias force and channel geometry are selected so that simultaneous push-and-rotate actions are required to transition from the locked position.

All ranges and ratio limits disclosed in the specification and claims may be combined in any manner. Unless specifically stated otherwise, references to “a,” “an,” and/or “the” may include one or more than one, and that reference to an item in the singular may also include the item in the plural.

Although the invention has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A dish assembly configured to be removably secured to a support structure comprising:
a dish having a bottom circular locking portion defining a plurality of channels each including an axial entry and a circumferential segment; and
a clamp including:
a support-surface-engaging portion configured to overlie a support surface of the support structure and including a circular indent configured to receive the circular locking portion;
a plurality of protrusions extending from a wall of the indent and configured to enter the vertical entries of the circular locking portion when the dish is pressed into the indent and to engage the circumferential segments upon relative rotation between the dish and the clamp to releasably lock the dish to the clamp;
a bias element located within the indent and configured to urge the dish away from the support surface when the circular locking portion is received in the indent to resist reverse rotation of the dish from a locked position;
a brace assembly mechanically coupled to the support-surface-engaging portion and configured, when actuated, to engage an edge of the support structure to urge the support-surface-engaging portion against the support surface to secure the clamp to the support structure.

2. The dish assembly of claim 1, wherein:
the indent includes a central opening; and
the bias element comprises a plurality of resilient biasing members extending from an interior annular ring of the indent into the central opening and inclined upward, the biasing members being configured to contact a bottom surface of the circular locking portion when received in the indent.

3. The dish assembly of claim 1, wherein the brace assembly comprises:
a lateral member configured to engage the edge of the support structure and defining a slot extending through a thickness of the lateral member from an interior side adjacent the support-surface-engaging portion to an exterior side;
an actuator including a grip coupled to a screw, the screw extending through the slot from the exterior side to the interior side;
a pivot pin having a threaded bore receiving the screw; and
a movable brace including a proximal end pivotably coupled to the lateral member, a pivot connector between the proximal end and the distal end and pivotably coupled to the pivot pin, a distal end, and a contact structure configured to engage the support structure, wherein:
rotation of the grip in a tightening direction advances the screw in the threaded bore to draw the pivot pin toward the grip, thereby decreasing an angle between the lateral member and the movable brace and moving the movable brace to urge the support-surface-engaging portion against the support surface; and
rotation of the grip in an opposite loosening direction retracts the screw relative to the threaded bore to drive the pivot pin away from the grip, thereby increasing the angle between the lateral member and the movable brace and moving the movable brace to reduce the urging of the support-surface-engaging portion against the support surface.

4. The dish assembly of claim 3, wherein the contact structure includes a pressure plate pivotably coupled adjacent the distal end of the movable brace, such that movement of the movable brace to urge the support-surface-engaging portion against the support surface results in the pressure plate pressing against an underside of the support structure.

5. The dish assembly of claim 4, wherein the pressure plate is pivotably coupled to the movable brace, such that the pressure plate is rotatable relative to the movable brace.

6. The dish assembly of claim 3, wherein the contact structure includes a curved portion between the pivot connector and the distal end and is configured to engage a bar of the support structure.

7. The dish assembly of claim 1, wherein the dish is a bowl, plate, or tray.

8. The dish assembly of claim 1, wherein the protrusions are evenly spaced around the wall of the indent.

9. The dish assembly of claim 1, wherein release of the dish from the clamp requires depressing the dish toward the support surface against the bias element and rotating the dish relative to the clamp in a direction opposite a locking direction to align the plurality of protrusions with the axial entry of the plurality of channels to permit withdrawal of the circular locking portion from the indent

10. A clamp configured to removably secure a dish having a bottom circular locking portion to a support structure, the clamp comprising:
a support-surface-engaging portion configured to overlie a support surface of the support structure and including a circular indent configured to receive the circular locking portion of the dish, wherein the circular locking portion defines a plurality of channels each including an axial entry and a circumferential segment;
a plurality of protrusions extending from a wall of the indent and configured to enter the vertical entries of the circular locking portion when the dish is pressed into the indent and to engage the circumferential segments upon relative rotation between the dish and the clamp to releasably lock the dish to the clamp;
a bias element located within the indent and configured to urge the dish away from the support surface when the circular locking portion is received in the indent to resist reverse rotation of the dish from a locked position;
a brace assembly mechanically coupled to the support-surface-engaging portion and configured, when actuated, to engage an edge of the support structure to urge the support-surface-engaging portion against the support surface to secure the clamp to the support structure.

11. The clamp of claim 10, wherein:
the indent includes a central opening; and
the bias element comprises a plurality of resilient biasing members extending from an interior annular ring of the indent into the central opening and inclined upward, the biasing members being configured to contact a bottom surface of the circular locking portion when received in the indent.

12. The clamp of claim 10, wherein the brace assembly comprises:
a lateral member configured to engage the edge of the support structure and defining a slot extending through a thickness of the lateral member from an interior side adjacent the support-surface-engaging portion to an exterior side;
an actuator including a grip coupled to a screw, the screw extending through the slot from the exterior side to the interior side;
a pivot pin having a threaded bore receiving the screw; and
a movable brace including a proximal end pivotably coupled to the lateral member, a pivot connector between the proximal end and the distal end and pivotably coupled to the pivot pin, a distal end, and a contact structure configured to engage the support structure, wherein:
rotation of the grip in a tightening direction advances the screw in the threaded bore to draw the pivot pin toward the grip, thereby decreasing an angle between the lateral member and the movable brace and moving the movable brace to urge the support-surface-engaging portion against the support surface; and
rotation of the grip in an opposite loosening direction retracts the screw relative to the threaded bore to drive the pivot pin away from the grip, thereby increasing the angle between the lateral member and the movable brace and moving the movable brace to reduce the urging of the support-surface-engaging portion against the support surface.

13. The clamp of claim 12, wherein the contact structure includes a pressure plate pivotably coupled adjacent the distal end of the movable brace, such that the moving of the movable brace to urge the support-surface-engaging portion against the support surface results in the pressure plate pressing against an underside of the support structure.

14. The clamp of claim 13, wherein the pressure plate is pivotably coupled to the movable brace, such that the pressure plate is rotatable relative to the movable brace.

15. The clamp of claim 12, wherein the contact structure includes a curved portion between the pivot connector and the distal end and is configured to engage a bar of the support structure.

16. The clamp of claim 10, wherein the protrusions are evenly spaced around the wall of the indent.

17. The clamp of claim 1, wherein release of the dish from the clamp requires depressing the dish toward the support surface against the bias element and rotating the dish relative to the clamp in a direction opposite a locking direction to align the plurality of protrusions with the axial entry of the plurality of channels to permit withdrawal of the circular locking portion from the indent.
